(19) United States
(12) Patent Application Publication
(10) Pub. No.: US 2025/0042781 A1
(43) Pub. Date: Feb. 6, 2025

(54) ECO-FRIENDLY METHOD, APPARATUS, AND SYSTEM FOR PRECIPITATION AND COLLECTION OF DISSOLVED SUPPORT MATERIAL

(71) Applicant: ORYX ADDITIVE, INC., Tempe, AZ (US)

(72) Inventors: Noah TREMBLAY, Pepperell, MA (US); David M. DIETRICH, Chandler, AZ (US); Solomon R. PENA, Gilbert, AZ (US)

(21) Appl. No.: 18/717,414

(22) PCT Filed: Dec. 8, 2022
(86) PCT No.: PCT/US2022/081205

§ 371 Date: Jun. 6, 2024

Related U.S. Application Data
(60) Provisional application No. 63/287,454, filed on Dec. 8, 2021.
(60) Provisional application No. 63/316,871, filed on Mar. 4, 2022.

(51) Int. Cl. C02F 1/52; B01D 37/00; B01D 39/16; B01D 39/18; B29B 17/02; B29C 64/40; B33Y 40/20; C02F 1/00; C02F 9/00; C02F 11/06; C02F 11/12; C02F 101/30; C02F 103/34

(52) U.S. Cl. CPC C02F 1/5245; B01D 37/00; B01D 39/1623; B01D 39/18; B29B 17/02; C02F 1/001; C02F 9/00; B01D 2239/0618; B29B 2017/0224; B29B 2017/0293; B29C 64/40; B29K 2995/0062; B33Y 40/20; C02F 11/06; C02F 11/12; C02F 2101/30; C02F 2103/34

(57) ABSTRACT

The present disclosure relates to a method and an apparatus for precipitating and collecting a support material dissolved in an aqueous solution after production of an additively manufactured part wherein a divalent metal is added to the aqueous solution to induce precipitation the support material.

### CROSS-REFERENCE TO RELATED APPLICATIONS

This disclosure claims the benefit, including the filing date, of both: U.S. Provisional Patent No. 63/316,871, entitled “Eco-Friendly Method, Apparatus, and System for Precipitation and Collection of Dissolved Support Material” which was filed on Mar. 4, 2022, and U.S. Provisional Patent No. 63/287,454, entitled “Eco-Friendly Method, Apparatus, and System for Precipitation and Collection of Dissolved Support Material” which was filed on Dec. 8, 2021, the entire disclosures of both of which are hereby incorporated herein by this reference.

### TECHNICAL FIELD

The present disclosure relates to additive manufacturing technologies for building three-dimensional (3D) models and support structures. In particular, the present disclosure relates to methods, solutions, and apparatuses for precipitating and collecting dissolved support material from 3D models built with additive manufacturing systems, such as extrusion-based additive manufacturing systems.

### BACKGROUND

Additive manufacturing processes, such as 3D printing (e.g. Selective Laser Sintering (SLS), Stereolithography (SLA), fused deposition modeling (FDM), material jetting (MJ), electron beam (e-beam), etc.) have enabled the production of parts having complex geometries that would never be possible through traditional manufacturing techniques, such as casting, injection molding, or forging. However, additive manufacturing produces parts that require significant efforts to remove unwanted support material. The support material is needed during the manufacturing process to support portions of the part as the part is being manufactured in order to achieve complex geometries. After the manufacturing process is completed, the unwanted support material must be removed and/or rough surfaces may need to be polished.

The support material itself can have a complex geometry and can also be extensive. Additionally, since additive manufacturing manufactures a part in discrete layers, the surface of a part is often rough, because adjacent layers may not end in similar locations thereby leaving a rough bumpy outer surface. Such a rough outer surface is unappealing from a visual standpoint, and the uneven surface can create stress concentrations, which could develop during testing or use of the part and lead to untimely failure of the part.

### SUMMARY

The present disclosure provides a method of precipitating and collecting a support material dissolved in an aqueous solution after production of an additively manufactured part, the method comprising: adding a divalent metal to the aqueous solution; and removing a precipitate formed from the support material with a filtering agent, wherein the divalent metal is selected from the group consisting of beryllium (Be²⁺), magnesium (Mg²⁺), calcium (Ca²⁺), strontium (Sr²⁺), barium (Ba²⁺), vanadium (V²⁺), chromium (Cr²⁺), manganese (Mn²⁺), iron (Fe²⁺), cobalt (Co²⁺), nickel (Ni²⁺), copper (Cu²⁺), zinc (Zn²⁺), and combinations thereof.

In one aspect, the divalent metal is calcium (Ca²⁺) dissolved in water or as a salt. In another aspect, the salt is selected from the group consisting of calcium chloride, calcium acetate, calcium carbonate, calcium citrate, calcium gluconate, calcium phosphate, calcium bromide, calcium iodide, calcium sulfide, calcium sulfate, and combinations thereof.

In some aspects, the filtering agent comprises one or more selected from the group consisting of diatomite, perlite, cellulose, kaolinite, silica gel, zeolite, synthetic fiber, natural fiber, saw dust, hay, straw, dried grasses, beach sand, natural mulches and composts with sufficient levels of cellulose and/or fibers to catch solids, and recycled cloth from used clothing or manufacturing scraps. In one aspect, the filtering agent comprises cellulose. In another aspect, the filtering agent comprises a synthetic fiber selected from the group consisting of polyethylene (PE), high-density polyethylene (HDPE), polypropylene (PP), halogenated polyethylenes, polyoxymethalines (POM), polyamides (PA), and combinations thereof.

In certain aspects, the method further comprises agitating the aqueous solution after adding the divalent metal and prior to removing the precipitate.

In some aspects, a base has been applied to the aqueous solution to facilitate dissolution of the support material and the method further comprises adding an acid to the aqueous solution to facilitate precipitation of the support material.

In other aspects, the aqueous solution further comprises a pH indicator selected from the group consisting of Alizarine Yellow R, Indigo Carmine, and Universal Indicator; and the pH indicator precipitates with the support material thereby imparting a color to the precipitate.

In one aspect, the support material is used during Polyjet printing, Fused Deposition Modeling (FDM) printing, Fused Filament Fabrication (FFF) printing, Selective Thermoplastic Electrophotographic Process (STEP) 3-D printing technology, and/or Material Jetting (MJ) printing. In another aspect, the support material is selected from the group consisting of SUP706, SUP707, SUP708, SR20, SR30, SR35, SR100, SR110, SW-100, and a combination thereof.

In some aspects, the method further comprises: (a) drying and incinerating the precipitate; or (b) providing the precipitate as a growth substrate for plants, algae, or fungus. In one aspect, the precipitate is provided as a growth substrate and is combined with seeds, seedlings, mycelium, spores, or a starting culture. In another aspect, the method produces sustainable waste streams of resultant liquid and solids products.

In another aspect, the disclosure provides an apparatus for precipitating and collecting a support material dissolved in an aqueous solution after production of an additively manufactured part, the apparatus comprising: a chamber for containing a support material dissolved in an aqueous solution after production of an additively manufactured part; a divalent metal dissolved in water or as a solid salt to be added to the aqueous solution; and a filtering agent for removing a precipitate formed from the support material, wherein the divalent metal is selected from the group consisting of beryllium (Be²⁺), magnesium (Mg²⁺), calcium (Ca²⁺), strontium (Sr²⁺), barium (Ba²⁺), vanadium (V²⁺), chromium (Cr²⁺), manganese (Mn²⁺), iron (Fe²⁺), cobalt (Co²⁺), nickel (Ni²⁺), copper (Cu²⁺), zinc (Zn²⁺), and combinations thereof.

In some aspects, the apparatus further comprises an agitator for shaking the aqueous solution after adding the divalent metal and prior to removing the precipitate.

In other aspects, the apparatus produces a final waste article that is: (a) dried and incinerated; or (b) used as a growth substrate for plants, algae, bacteria, or fungi.

### BRIEF DESCRIPTION OF THE DRAWINGS

FIG. 1 depicts an image showing the effective precipitation SR-30 support material from solution using calcium chloride and filtration of the resulting precipitate from the solution with high density polyethylene (HDPE) non-woven fabric.

FIG. 2 depicts an image showing the effective precipitation SR-30 support material from solution using magnesium chloride and filtration of the resulting precipitate from the solution with polypropylene non-woven fabric.

### DETAILED DESCRIPTION

As used herein and in the appended claims, the singular forms “a,” “an,” and “the” include plural referents unless the context clearly dictates otherwise. For example, “a” or “an” means “at least one” or “one or more.”

Throughout this disclosure, various aspects of the claimed subject matter are presented in a range format. It should be understood that the description in range format is merely for convenience and brevity and should not be construed as an inflexible limitation on the scope of the claimed subject matter. Accordingly, the description of a range should be considered to have specifically disclosed all the possible sub-ranges as well as individual numerical values within that range. For example, where a range of values is provided, it is understood that each intervening value, between the upper and lower limit of that range and any other stated or intervening value in that stated range is encompassed within the claimed subject matter. The upper and lower limits of these smaller ranges may independently be included in the smaller ranges, and are also encompassed within the claimed subject matter, subject to any specifically excluded limit in the stated range. Where the stated range includes one or both of the limits, ranges excluding either or both of those included limits are also included in the claimed subject matter. This applies regardless of the breadth of the range.

The term “providing”, such as for “providing a material” and the like, when recited in the claims, is not intended to require any particular delivery or receipt of the provided item. Rather, the term “providing” is merely used to recite items that will be referred to in subsequent elements of the claim(s), for purposes of clarity and ease of readability.

As used herein, the term “dication” is any cation, of general formula X²⁺, formed by the removal of two electrons from a neutral species. A “divalent metal” is a metal found in the form of a dication when in the form of a salt or dissolved in water.

Unless otherwise specified, temperatures referred to herein are based on atmospheric pressure (i.e. one atmosphere).

The present disclosure describes finishing solutions for removing undesirable material from an FDM, Polyjet, Fused Filament Fabrication (FFF), Selective Thermoplastic Electrophotographic Process (STEP) 3-D printing technology, Selective Thermoplastic Electrophotographic Process (STEP) 3-D printing technology, and/or Material Jetting (MJ) 3D-printed object. MJ consists of Polyjet and Mimaki's printing process. Undesirable material of an unfinished object is dissolved by a finishing solution that is in keeping with the disclosure, and in doing so provides a finished object.

As used herein, unless otherwise indicated, the term “support material” refers to material that is operatively arranged to support portions of an object during an additive manufacturing process, but which are undesired once the manufacturing process is complete. Support material can comprise the same material as the object that is being manufactured or can be made of a different material. Materials that can be removed during finishing include, but are not limited to, materials used during Polyjet 3D printing (e.g., SUP706, SUP707, SUP708, and combinations thereof), FDM 3D printing (e.g., SR20, SR30, SR35, SR100, SR110, and combinations thereof), MJ printing (e.g., SW-100) and/or Selective Thermoplastic Electrophotographic Process (STEP) 3-D printing technology.

To remove support material from rough surfaces, and to remove other undesirable material, chemicals may be applied to the object. These chemicals may be in the form of a liquid solution. The chemicals facilitate the dissolution of the support material into an aqueous solution. However, the dissolved support material can be toxic and should be disposed of in accordance with local regulations.

There is a need for a method, solution, and apparatus for safely precipitating and collecting support material from a part made via additive manufacturing techniques. The solutions and methods provided herein use non-toxic materials to efficiently precipitate and collect dissolved support material to facilitate its disposal in an environmentally friendly manner.

Some finishing processes are mechanical in nature (e.g., abrasion techniques, such as sanding), and others are a combination of mechanical processes and chemical processes. Chemical finishing solutions may be caustic. In a conventional machine that uses chemical finishing solutions to remove undesirable material (e.g., undesirable support material), an unfinished 3D-printed object may be subjected to a process to remove undesirable material, and thereby provide a finished object. In one such process, the unfinished object is placed (e.g., partially or completely submerged) in a tank that contains (e.g., at least partially filled) a liquid finishing solution. While in the finishing solution, the object may be subjected to mechanical agitation, abrasion, and/or heating in order to remove undesirable material from the object. Mechanical agitation may occur by moving the liquid finishing solution (e.g., via a pump) and/or by using ultrasound. In other such processes, the object is subjected to a liquid spray. In those processes, the object is placed in a chamber, and a pump is used to force the liquid finishing solution through one or more nozzles, which both applies the finishing solution to the object and mechanically agitates the object. In such processes, the liquid may include chemical solvents to dissolve support material, and thereby create a finished or nearly finished form of the object. Heat from a heat source may be used to maintain the finishing solution at a desired temperature. The support material may be removed thermally, chemically, mechanically, or via a combination of two or more of these general processes.

Additive manufactured parts may be made using numerous different methods, classes of materials (e.g., plastics, metals), specific build materials (e.g., nylon within the plastics class, aluminum within the metals class) and support materials.

### Support Material

The present disclosure provides methods, systems, and solutions for removal of support material and support structures from a 3D-printed object. Non-limiting examples of suitable support material and support structures to be removed include those disclosed in Priedeman et al., U.S. Pat. No. 7,754,807; Hopkins et al., U.S. Patent Application Publication No. 2010/0096072; and Rodgers, U.S. patent application Ser. No. 13/081,956; and those commercially available under the trade designations “SR-10”, “SR-20”, “SR-30”, “SR-35”, “SR-100”, “SR-110”, “SUP-705”, “SUP-706”, “SUP-708” Support Materials from Stratasys, Inc., Eden Prairie, Minnesota including any combination thereof.

### Divalent Metals

In some aspects, a composition comprising a divalent metal facilitates precipitation of the dissolved support material from an aqueous solution. Non-limiting examples of the divalent metal include beryllium (Be²⁺), magnesium (Mg²⁺), calcium (Ca²⁺), strontium (Sr²⁺), barium (Ba²⁺), vanadium (V²⁺), chromium (Cr²⁺), manganese (Mn²⁺), iron (Fe²⁺), cobalt (Co²⁺), nickel (Ni²⁺), copper (Cu²⁺), zinc (Zn²⁺), and combinations thereof. In one aspect, the divalent metal is calcium (Ca²⁺).

In one aspect, divalent metal is dissolved in water. In another aspect, the divalent metal is a salt. Examples of calcium salts include calcium chloride, calcium acetate, calcium carbonate, calcium citrate, calcium gluconate, calcium phosphate, calcium bromide, calcium iodide, calcium sulfide, and calcium sulfate. Examples of nickel salts include nickel chloride, nickel sulfate, and nickel nitrate. Examples of magnesium salts include magnesium sulfate, magnesium carbonate, and magnesium citrate. Examples of magnesium salts include manganese salts include manganese chloride, manganese acetate, manganese nitrate, and manganese sulfate. Examples of copper salts include copper (II) sulfate, copper (II) chloride, copper (II) nitrate, copper (II) oxide, copper (II) acetate, copper (II) carbonate, copper (II) phosphate, and copper (II) gluconate. Examples of zinc salts include zinc chloride, zinc sulfate, zinc oxide, zinc nitrate, and zinc acetate.

In some aspects, a stoichiometric equivalent of about 1 molar equivalent of divalent metal cations (e.g., calcium, magnesium, etc.) to about 2 molar equivalents of sodium in the sodium hydroxide used to dissolve the support material. In other aspects, the molar ratio of divalent metal cations to sodium in the sodium hydroxide is about 1.5, about 2.0, about 2.5, about 3.0, about 3.5, about 4.0, about 4.5, or about 5.0. In other aspects, the molar ratio of divalent metal cations to sodium in the sodium hydroxide is at least 1.0, at least 1.5, at least 2.0, at least 2.5, at least 3.0, at least 3.5, at least 4.0, at least 4.5, or at least 5.0. In yet other aspects, the molar ratio of divalent metal cations to sodium in the sodium hydroxide is between 1.0 and 5.0, between 1.5 and 5.0, between 2.0 and 5.0, between 1.0 and 4.0, between 1.5 and 4.0, between 2.0 and 4.0, between 1.0 and 3.0, between 1.5 and 3.0, or between 2.0 and 3.0.

### pH Indicators

In one aspect, a pH indicator is added to the aqueous solution containing the dissolved support material. The pH indicator visually indicates when the pH of the solution has decreased below a certain threshold. The colored dye that comprises the pH indicator precipitates with the dissolved support material thereby confirming that the colored precipitate has been removed from the aqueous solution leaving behind a clear solution.

A pH indicator is a halochromic chemical compound added in small amounts to a solution so the pH (acidity or basicity) of the solution can be determined visually. Generally, a strong base is neutralized and the pH decreases in the aqueous solution during the dissolution of the support material. As this occurs, the pH indicator provides a visual indication of the need to add more strong base to the aqueous solution.

Non-limiting examples of pH indicators that may be added to the aqueous solution are outlined in Table 1. In one aspect, the pH indicator is Alizarine Yellow R and a color change from blue to yellow indicates the need to add a strong base. In another aspect, the pH indicator is Indigo Carmine and a color change from yellow to blue indicates the need to add a strong base. In another aspect, the pH indicator is Universal Indicator and a color change from indigo or violet to blue indicates the need to add a strong base.

TABLE 1
pH Indicators Indicating Neutralization of Sodium Hydroxide

| | pH Range in which Color | Color Change as pH |
|---|---|---|
| Indicator | Change Occurs | Increases |
| Alizarine Yellow R | 10.1-12.0 | yellow to blue |
| Indigo Carmine | 11.4-13.0 | blue to yellow |
| Universal Indicator | about 11 | blue to indigo or violet |

### Filtering Agents

A filtering agent may be used to remove the dissolved support material after it has been precipitated. In certain aspects, the filtering agent may include one or more selected from the group consisting of diatomite, perlite, cellulose, kaolinite, silica gel, zeolite, synthetic fiber, natural fiber, saw dust, hay, straw, dried grasses, beach sand, natural mulches and composts with sufficient levels of cellulose and/or fibers to catch solids, and recycled cloth from used clothing or manufacturing scraps. Examples of synthetic fibers include polyethylene (PE), high-density polyethylene (HDPE), polypropylene (PP), halogenated polyethylenes, polyoxymethalines (POM), and polyamides (PA). One example of cellulose is α-celluose. In some aspects, the filtering agent is cellulose.

The present disclosure is further illustrated by the following examples that should not be construed as limiting. The contents of all references, patents, and published patent applications cited throughout this application, as well as the Figures, are incorporated herein by reference in their entirety for all purposes.

### EXAMPLES

### Example 1. Precipitation and Removal of SR-30 Support Material from Solution with Calcium Chloride

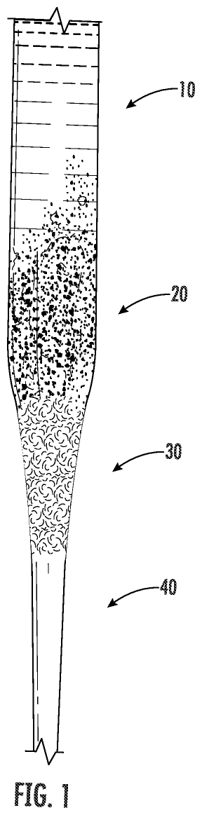

SR-30 support material from Stratasys® was dissolved in an aqueous solution by increasing the pH above 9. To dispose of the dissolved SR-30 in an efficient and eco-friendly manner, a solution of calcium chloride (CaCl₂)) was added to the solution until SR-30 precipitated. The solution with the precipitated SR-30 support material 10 was then filtered through activated charcoal 20 and a high density polyethylene (HDPE) non-woven fabric 30 producing a clear filtrate 40 containing only sodium chloride and trace amounts of calcium chloride (see FIG. 1).

Previously known methods generally require the acid neutralization of the solution below a pH of 9 to precipitate the support material, and these methods often produce a filtrate containing small amounts of dissolved support material and acid. By using divalent cation salts such as calcium chloride, efficient precipitation as achieved at pH's ranging from about 9 to about 13 with no detectable SR-30 support material in the filtrate.

### Example 2. Precipitation and Removal of SR-30 Support Material from Solution with Magnesium Chloride

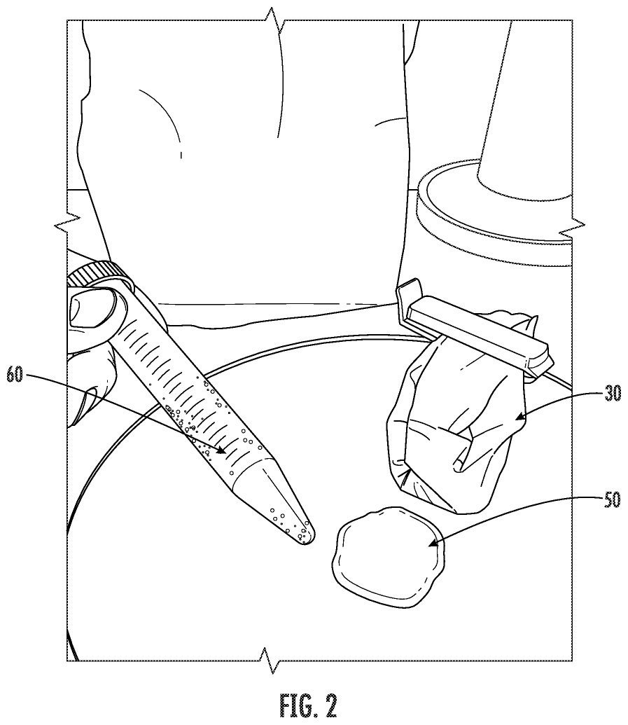

Another salt of a divalent cation was evaluated for its ability to efficiently precipitate SR-30 support material from solution without the need to acid neutralize the solution. A saturated solution of magnesium chloride was added dropwise to a solution of dissolved SR-30 until the SR-30 seized under the influence of the magnesium. The resultant SR-30 precipitate 60 was filtered through a polypropylene non-woven fabric 30 to generate a clear filtrate/solution 50 (see FIG. 2).

### Example 3. Investigation of Amount of Divalent Cation Required for Precipitation of SR-30 Support Material from Solution

After several repetitions of experiments similar to that described in Example 1, it was found that relatively small amounts of calcium precipitate a stoichiometric amount of dissolved support material at low concentrations down to 50 g of SR-30 dissolved in 11 gallons of pH 13.0 sodium hydroxide.

To get around the difficulty of stoichiometrically quantifying the SR-30 support material, the ratio of calcium chloride required to precipitate the SR-30 support material to the sodium hydroxide used to dissolve the SR-30 support material into solution was determined.

For an 11 gallon bath where 275 g (i.e., 6.88 mol) of sodium hydroxide was used to dissolve support material until a pH of under 10 is achieved, 350 g (i.e., 3.15 mol) of calcium chloride was sufficient to precipitate the dissolved support material. Therefore, to effectively precipitate the dissolved support material requires a stoichiometric equivalent of 1 molar equivalent of divalent metal cations (e.g., calcium) to 2 molar equivalents of sodium in the sodium hydroxide used to dissolve the support material.

All headings are for the convenience of the reader and should not be used to limit the meaning of the text that follows the heading, unless so specified.

Unless defined otherwise, all technical and scientific terms herein have the same meaning as commonly understood by one of ordinary skill in the art to which this disclosure belongs. Although any methods and materials, similar or equivalent to those described herein, can be used in the practice or testing of the present disclosure, the preferred methods and materials are described herein.

The publications discussed herein are provided solely for their disclosure prior to the filing date of the present application. Nothing herein is to be construed as an admission that the present disclosure is not entitled to antedate such publication by virtue of prior disclosure.

While the disclosure has been described in connection with specific embodiments thereof, it will be understood that it is capable of further modifications and this application is intended to cover any variations, uses, or adaptations of the disclosure following, in general, the principles of the disclosure and including such departures from the present disclosure as come within known or customary practice within the art to which the disclosure pertains and as may be applied to the essential features hereinbefore set forth and as follows in the scope of the appended claims.

What is claimed is:

1. A method of precipitating and collecting a support material dissolved in an aqueous solution after production of an additively manufactured part, the method comprising:
adding a divalent metal to the aqueous solution; and
removing a precipitate formed from the support material with a filtering agent,
wherein the divalent metal is selected from the group consisting of beryllium (Be²⁺), magnesium (Mg²⁺), calcium (Ca²⁺), strontium (Sr²⁺), barium (Ba²⁺), vanadium (V²⁺), chromium (Cr²⁺), manganese (Mn²⁺), iron (Fe²⁺), cobalt (Co²⁺), nickel (Ni²⁺), copper (Cu²⁺), zinc (Zn²⁺), and combinations thereof.

2. The method of claim 1, wherein the divalent metal is calcium (Ca²⁺) dissolved in water or as a salt.

3. The method of claim 2, wherein the salt is selected from the group consisting of calcium chloride, calcium acetate, calcium carbonate, calcium citrate, calcium gluconate, calcium phosphate, calcium bromide, calcium iodide, calcium sulfide, calcium sulfate, and combinations thereof.

4. The method of any one of claims 1 to 3, where in the filtering agent comprises one or more selected from the group consisting of diatomite, perlite, cellulose, kaolinite, silica gel, zeolite, synthetic fiber, natural fiber, saw dust, hay, straw, dried grasses, beach sand, natural mulches and composts with sufficient levels of cellulose and/or fibers to catch solids, and recycled cloth from used clothing or manufacturing scraps.

5. The method of claim 4, wherein the filtering agent comprises cellulose.

6. The method of claim 4, wherein the filtering agent comprises a synthetic fiber selected from the group consisting of polyethylene (PE), high-density polyethylene (HDPE), polypropylene (PP), halogenated polyethylenes, polyoxymethalines (POM), polyamides (PA), and combinations thereof.

7. The method of any one of claims 1 to 6, further comprising agitating the aqueous solution after adding the divalent metal and prior to removing the precipitate.

8. The method of any one of claims 1 to 7, wherein a base has been applied to the aqueous solution to facilitate dissolution of the support material and the method further comprises adding an acid to the aqueous solution to facilitate precipitation of the support material.

9. The method of any one of claims 1 to 8, wherein the aqueous solution further comprises a pH indicator selected from the group consisting of Alizarine Yellow R, Indigo Carmine, and Universal Indicator; and
the pH indicator precipitates with the support material thereby imparting a color to the precipitate.

10. The method of any one of claims 1 to 9, wherein the support material is used during Polyjet printing, Fused Deposition Modeling (FDM) printing, Fused Filament Fabrication (FFF) printing, Selective Thermoplastic Electrophotographic Process (STEP) 3-D printing technology and/or Material Jetting (MJ) printing.

11. The method of claim 10, wherein the support material is selected from the group consisting of SUP706, SUP707, SUP708, SR20, SR30, SR35, SR100, SR110, SW-100, and a combination thereof.

12. The method of any one of claims 1 to 11, further comprising:
(a) drying and incinerating the precipitate; or
(b) providing the precipitate as a growth substrate for plants, algae, bacteria or fungi.

13. The method of claim 12, wherein the precipitate is provided as a growth substrate and is combined with seeds, seedlings, mycelium, spores, or a starting culture.

14. The method of any one of claims 1 to 13, wherein the method produces sustainable waste streams of resultant liquid and solids products.

15. An apparatus for precipitating and collecting a support material dissolved in an aqueous solution after production of an additively manufactured part, the apparatus comprising:
a chamber for containing a support material dissolved in an aqueous solution after production of an additively manufactured part;
a divalent metal dissolved in water or as a solid salt to be added to the aqueous solution; and
a filtering agent for removing a precipitate formed from the support material,
wherein the divalent metal is selected from the group consisting of beryllium (Be²⁺), magnesium (Mg²⁺), calcium (Ca²⁺), strontium (Sr²⁺), barium (Ba²⁺), vanadium (V²⁺), chromium (Cr²⁺), manganese (Mn²⁺), iron (Fe²⁺), cobalt (Co²⁺), nickel (Ni²⁺), copper (Cu²⁺), zinc (Zn²⁺), and combinations thereof.

16. The apparatus of claim 15, wherein the divalent metal is calcium (Ca²⁺) dissolved in water or as a salt.

17. The apparatus of claim 16, wherein the salt is selected from the group consisting of calcium chloride, calcium acetate, calcium carbonate, calcium citrate, calcium gluconate, calcium phosphate, and combinations thereof.

18. The apparatus of any one of claims 15 to 17, where in the filtering agent comprises one or more selected from the group consisting of diatomite, perlite, cellulose, kaolinite, silica gel, zeolite, synthetic fiber, natural fiber, saw dust, hay, straw, dried grasses, beach sand, natural mulches and composts with sufficient levels of cellulose and/or fibers to catch solids, and recycled cloth from used clothing or manufacturing scraps.

19. The apparatus of claim 18, wherein the filtering agent comprises cellulose.

20. The apparatus of claim 19, wherein the filtering agent comprises a synthetic fiber selected from the group consisting of polyethylene (PE), high-density polyethylene (HDPE), polypropylene (PP), halogenated polyethylenes, polyoxymethalines (POM), polyamides (PA), and combinations thereof.

21. The apparatus of any one of claims 15 to 20, wherein the aqueous solution further comprises a pH indicator selected from the group consisting of Alizarine Yellow R, Indigo Carmine, and Universal Indicator; and
the pH indicator precipitates with the support material thereby imparting a color to the precipitate.

22. The apparatus of any one of claims 15 to 21, further comprising an agitator for shaking the aqueous solution after adding the divalent metal and prior to removing the precipitate.

23. The apparatus of any one of claims 15 to 22, wherein the support material is a material used during Polyjet printing, Fused Deposition Modeling (FDM) printing, Fused Filament Fabrication (FFF) printing, Selective Thermoplastic Electrophotographic Process (STEP) 3-D printing technology and/or Material Jetting (MJ) printing.

24. The apparatus of any one of claims 15 to 23, wherein the apparatus produces a final waste article that is:
(a) dried and incinerated; or
(b) used as a growth substrate for plants, algae, bacteria, or fungi.
